(19) United States
(12) Patent Application Publication
(10) Pub. No.: US 2011/0178827 A1
(43) Pub. Date: Jul. 21, 2011

(54) System for maximizing profit from public sale of tickets for a ticketed public event

(76) Inventor: Andrew Orenstein, New York, NY (US)

(21) Appl. No.: 12/807,199

(22) Filed: Aug. 31, 2010

Related U.S. Application Data
(60) Provisional application No. 61/336,310, filed on Jan. 21, 2010.

(51) Int. Cl. G06Q 10/00; G06Q 30/00

(52) U.S. Cl. 705/5

(57) ABSTRACT

A computer-implemented method for allocating a plurality of tickets to seats in a venue to a plurality of ticket purchasers, comprising the steps of forming a ranking of said seats from most desirable to least desirable, accepting a plurality of bids by one or more bidders for tickets to said seats, forming a ranking by monetary value of said bids from highest to lowest, and matching said seat ranking to said bid ranking, wherein the highest bid is assigned the most desirable seat and the lowest bid is assigned the least desirable seat.

### RELATIONSHIP TO OTHER APPLICATIONS AND PATENTS

The present invention draws priority from a pending U.S. Provisional patent application, Ser. No. 61/336,310, filed Jan. 21, 2010.

### TECHNICAL FIELD

The present invention relates to process and apparatus for selling tickets to ticketed public events such as sporting events or concerts; more particularly, to process and apparatus for conducting such a sale by bidding; and most particularly, to a computer-implemented process and apparatus for selling such tickets by bidding wherein profit for the initial seller is maximized.

### BACKGROUND OF THE INVENTION

Tickets for ticket public events such as limited engagement concerts and sporting events are typically sold on the internet and by phone by ticket vendors like Ticketmaster or at the venue box office. Some limited engagement events are so popular that blocks of shows with upwards of 80,000 tickets sell out to the general public in a matter of hours or even minutes.

When tickets are sold in this way, three things happen.

First, some people who are able to purchase at the appointed time get tickets, but because so many sales are occurring simultaneously, they are rarely the most desirable seats. These people would likely pay more for better seats and the privilege of spending less time to buy them.

Second, many of the tickets end up in the hands of ticket resellers (scalpers) who hire people to call, log on and wait in line. Scalpers recognize that once the shows are sold out that they can resell the tickets they have purchased at a substantial premium. Additionally, people who are lucky enough to get to a position where they are able to buy tickets buy extras with the intention of reselling them on websites that create a market for ticket reselling. This overbuying depletes the supply, making it harder for others to buy.

Third, it has come to light recently that artists have authorized ticket sellers to withhold blocks of tickets from sale to the general public and to make these tickets available on ticket scalping sites. This preserves for the artist the premium that is paid for these tickets, but this practice is perceived as unfair by those who believe they have access to prime seats at the general sale. Further, the scalping profits go to the artists rather than to the promoters of the events.

U.S. Pat. No. 6,704,713 issued Mar. 9, 2004 to Brett discloses an automated event ticket auctioning system that receives and evaluates bid information records received from a plurality of remote terminals. The bids correspond to one or more seats within a venue and correspond to at least one particular event, wherein the venue has a plurality of sections, each section having a plurality of seats. The automated event ticket auctioning system includes a memory storing a plurality of previously accepted bid information records, the previously accepted bid information records each including identification information, section identification, quantity information, and bid price information. The system further includes a central controlling computer operably connected to the memory and operable to first receive a message including a received bid information record from one of a plurality of remote terminals through a communication system. The received bid information record includes received identification information, received section identification, received quantity information, and received bid price information. The central controlling computer is further operable to determine a lowest minimum acceptable bid value corresponding to the received section information using the previously accepted bid information records stored in the memory, and store the received bid information record if a value represented by the received bid price information exceeds the lowest minimum acceptable bid value.

A serious shortcoming of the disclosed system is that it is a live auction wherein all the tickets in the venue are up for auction at once. For the period of time that the live auction is open, persons are bidding against one another on seats of their choosing; the system therefore is rather a multiplicity of auctions going on simultaneously for a plurality of seats/tickets. This system does not maximize revenue for the seller. Persons bidding in a live auction have an incentive to wait until the auction is about to close before entering a bid. This likely results in the placing of a bid that is sufficient to win the auction, but is less than the bidder might be willing to pay if given only one opportunity to state a “best and final offer”. Further, the disclosed system requires a bidder to bid on specific seats or sections of the venue. As the seats are graded ahead of time for desirability, it is inevitable in some instances that more desirable seats will sell for lower prices, because the individual auctions are essentially independent of one another. Lower bids for a seat of given desirability are discarded rather than being entered in the auction for the next lower in desirability.

What is needed in the art is an improved computer-implemented system for public sale of tickets to ticketed public events wherein scalping and reselling is effectively eliminated and profit is maximized for the event promoters and the performers.

It is a principal object of the present invention to maximize the profit from original sales of tickets to a ticketed public event by utilizing a computer-implemented system and method for configuring, optimizing, managing, and tracking the original sales.

### SUMMARY OF THE INVENTION

Briefly described, in a system in accordance with the present invention, all the seats in a venue are ranked ahead of time in terms of desirability, based on known factors such as sight lines, acoustical quality, accessibility, and the like. This ranking is made known to the general public. At a specific time, ticket sales to the general public are opened and are held open for a published length of time, preferably a few days. During this period, each potential ticket purchaser may enter a confidential bid for however much money the purchaser is willing to spend for a ticket. The purchaser may restrict the scope of his bid to only a particular section of the venue if he desires, recognizing that his bid will not be considered then for less desirable seating and if unsuccessful in bidding for the desired section his bid will be discarded. At the end of the bidding period, all bids are ranked by monetary value and the ranking is matched to the published desirability ranking. Thus, the most desirable seats will be purchased by the highest bidders, and further seat assignments in descending order of bid and desirability. The present system thus guarantees the maximum overall revenue for the event and virtually eliminates the pernicious practice of scalping. The profits previously enjoyed by scalpers now go directly to the original ticket seller.

Because of the number and complexity of variables, and because of the time constraints between the conclusion of input and the need to assign seats to buyers, only a computer-implemented system is thought to be practical.

### DESCRIPTION OF THE PREFERRED EMBODIMENTS

Instead of selling tickets to essentially random purchasers, many of whom are scalpers, the same ticket distribution network can auction tickets to the highest bidders. By allowing all buyers to tell the seller how much they are willing to pay, tickets will be sold for exactly the maximum amount that each consumer is willing to pay for them. Allocating tickets based on the amount buyers are willing to pay for them will—
Reduce ticket scalping and reselling and ensure that artists, promoters and sports teams realize the revenue that would otherwise be paid to scalpers;
Make tickets available at the time of initial sale to a greater number of buyers:
   By replacing the short period of time when tickets are sold with a period when bids can be submitted via the internet, by phone or at a box office; and
   By removing scalpers from the marketplace and eliminating the incentive to buy extra tickets to resell;
Ensure greater total revenue when compared to the arbitrary price structure that is typically set in the prior art; and
Allocate tickets according to willingness to pay rather than the ability to spend time logging on to or calling ticket vendor services.

For illustrative purposes, let us assume that a popular rock band plans to play three concerts in an arena that seats 20,000. Typically for concerts, the arena is divided into three price points. Seats on the floor cost $75.00. Seats in the lower bowl sell for $68.00 and seats in the upper bowl are priced to attract budget conscious fans and sell for $50.00. These prices reflect an effort to realize as much revenue as possible within the framework of prices that must be set and advertised prior to the concert. By definition, however, anyone who would consider paying $75 for a ticket would pay at least that much or more on the theory that a consumer will buy something only when the value of the item to him exceeds or is equal to the price that is charged for it. The inability to charge each consumer what he or she is willing to pay necessarily means that a great deal of revenue is lost. The same is true of the people who chose to buy the lower-priced tickets. Someone who chooses to buy tickets for $68 has decided that each ticket is worth that much or more, but less than $75, or that person would pay the higher price for a better seat. The fact that scalpers routinely buy tickets at face-value and resell them at a premium proves that no matter how prices are set, there are always customers willing to pay more. The fact that popular concerts routinely sell out leaving many unable to get tickets proves the point as well.

Ordinarily, dates and ticket prices are advertised in advance, and consumers are told that tickets will go on sale on a particular date and time through ticket vendors such as Ticketmaster and possibly at the venue box office. Long before the appointed hour, lines form outside the box office and at Ticketmaster outlets. When the tickets go on sale, phone lines and computer servers are jammed with more calls and attempted internet purchases than the systems can handle because people understand that the shows will sell out quickly. Because all of the available tickets are put on sale at once, there will always be a number of people who cannot make a purchase because they have other commitments.

People who chose to stand in line would likely pay more if it meant that they could avoid that chore and still have the opportunity to buy tickets. People who attempt to purchase tickets on line or by phone might likewise pay a premium to avoid spending this time and running the risk that they might not get through to make a purchase. In the meantime, each concert sells out, but a large number of tickets will be re-sold at a mark-up by professional scalpers and others who purchased additional tickets they do not intend to use but will instead sell at a profit. These resellers cater to those who were unable to get tickets when they went on sale at face value, and those who made no effort to purchase directly from legitimate ticket vendors but chose to wait for them to be resold by ticket brokers.

### Allocating Tickets Based on Willingness to Pay

Now, let us assume that the same rock band is booked for the same three shows at the same arena that seats 20,000. Instead of announcing that tickets priced at $75, $68 and $50 will go on sale at a specified date and time, the promoters advertise that tickets to all three shows will be auctioned, with those who submit the highest bids receiving the best seats. Instead of dividing the arena into three price points, each seat, row or section is ranked from most to least desirable. Seats are ranked by evaluating criteria such as proximity to the stage, sound quality, and the availability of amenities such as food service that are commonly found in luxury box seats. As explained below, the criteria for ranking seats are published much the same way that charts showing how much it costs to sit in any given section are published currently.

The concert advertisement states that bids will be accepted at any time in stated period of time, for example three days, with all submitted bids being treated equally; this eliminates the crush that occurs in the prior art when tickets are first put on sale. The time period needs to be sufficient only to guarantee that those who choose to place a bid, online, by phone or in person can be accommodated without having to wait in line, call, or log on the moment the bid period begins. This method has the added advantage of allowing people to place proposed orders at any time, thereby increasing buyer convenience and enlarging the pool of prospective buyers. When a customer calls, visits, or logs on, the customer is given the option of specifying which of the advertised dates are acceptable, and the customer can be given the option of limiting the tickets they are willing to purchase. For example, a buyer might specify a willingness to purchase two tickets for $85 each. The buyer can state that only three of the five advertised dates are acceptable, and that he or she does not want seats in the upper bowl, even if that is all that is available for the price he or she is willing to pay. For internet purchases, these selections can be made by navigating on-screen menus. For sales over the phone or in person, a sales operator can confirm and enter these details into a computer. Once the bidder's choices are recorded and credit card information accepted, a receipt with a bid number is issued. Once a bid is placed, the bidder has committed to pay the bid price for the number of tickets requested, preferably by submission of a valid credit card number at the time of bidding, but the credit card is not charged unless tickets are issued. When a bid is submitted, the prospective buyer is warned that his or her offer is irrevocable, and that if tickets are allocated then the credit card will be charged. Cash sales can be accommodated at ticket vendor outlets and the box office, and refunds later given at the point of service if tickets are not allocated. Refunds for concerts that are cancelled can be handled the same way that they are handled in the present art.

At the conclusion of the bidding period, ticket buyers are notified by email, and tickets are delivered by regular or email or are left at “will-call” to be picked up at the event. Those who did not bid high enough to receive tickets are also notified by email. For those who want to know that tickets were allocated fairly, the results of the auction can be made available online as described below. This may appeal to those who might otherwise feel that the best tickets are held aside for VIPs or who might otherwise not trust that the best tickets were allocated to the highest bidders. This represents an enormous improvement over the way that internet ticket sales are currently handled, since currently there is no way to verify that the first bidders to log on are the first bidders allowed to buy tickets, or that any given buyer actually gets the best available seat for his rank on the bidding and seat selection lists.

### Seat Ranking—Transparency

Unlike events that run for a sufficiently long period of time such that tickets are not scarce, in the prior art when people seek to buy tickets to a limited engagement concert or event, they generally do not set out to purchase specific seats. Typically, they select the price point they are willing to pay and rely on the vendor to give them the “best available” seats within this parameter. When these tickets are purchased online, the buyer has the option of declining to conclude the purchase if he or she does not like the seats that are offered, but generally, people take it on faith that the seats they are offered are actually the best ones available at the agreed upon price.

A system in accordance with the present invention depends upon an objective/subjective computerized ranking of seats from most to least desirable before ticket sales begin. Whether this ranking is done seat by seat, row by row, or section by section, the ordination can be published ahead of time so that ticket buyers have faith in the promise to match the people who are willing to pay the most with the best seats and so on down to the worst seats in the house.

The seat ranking must be done in advance, and once completed can be standardized so that all concerts at a particular venue will use the same ranking or some easily understood modification of it. The ranking of seats will take into account, among other factors, the distance from the stage, sound quality, and the availability of amenities, but this is not important so long as those who wish to see how the seats are ranked have the option to do so.

When individuals go to purchase tickets, whether online or at a ticket vending site, a map of the venue as it will be configured for the event should be available on a computer monitor. By using a computer mouse or similar device, the buyer will be allowed to click on an area or section of seats and see an enlarged map showing the rank assigned to each individual seat, row, or section. In this way, people will be able to understand how the seats are ranked before making a purchase.

In the event that several people submit the exact offer to purchase, the “tie” can be resolved in any of several ways. Within a given price point, the higher ranked seats can be allocated to the first to place an order, by random drawing, or by favoring those who offer to purchase larger numbers of seats. The method used to resolve this issue is not important so long as the method is clearly posted in the rules governing the sale.

Similarly, in the event that there are not sufficient tickets to fill the entire order of the person who makes the lowest offer for which some tickets might be allocated (in other words, the very lowest ranked seats), the rules of the sale can either provide that a partial order will or will not be filled, at the buyer's choosing. Either outcome is acceptable as long as it is disclosed in advance.

After the sales period has closed and tickets have been issued, people who wish to verify that the seats were allocated according to the ranking can return to the computer. When the user clicks on any given seat, its ranking will be displayed along with the price that was paid for the seat. This will assure those who wish to check that they received the appropriate seats based on the amount they paid. This is a distinct improvement over the current method where buyers are offered no assurance that they were in fact sold the best seats that were available at the time the purchase was made.

Tickets that are going to be held aside and not made available to the general public must be declared in advance in order to preserve the integrity of the ranking. This is an improvement over the present system, where purchasers do not know how many of the best seats in the venue are not available when they go to make a purchase. This does not prevent a concert promoter from buying tickets to be used for promotional purposes so long as the promoter is allocated tickets that are ranked commensurately with the price per ticket.

### Ticket Purchase Flexibility

One of the primary advantages of this system is that people have time to decide what they want and to enter their proposed purchase in a leisurely manner instead of having to make hasty decisions knowing that while they are making up their minds, the tickets are selling and prime seats are disappearing from the inventory. This added convenience will certainly increase the pool of prospective purchasers as compared to the prior art method of putting all tickets on sale at a particular time. This is because it will include people who would be shut out of short duration sale, and because it will include people who refuse to make purchases in the presently prevailing lottery atmosphere.

This method allows flexibility to both buyer and seller. Again, let us assume that a particular rock band is playing three concerts at a given venue on the 1^{st}, 3^{rd} and 5^{th} of June. A prospective buyer will have the option to bid on tickets to one or more of these shows at once and to set parameters for each. This is an improvement over the currently prevailing system where each show is treated independently with buyers not knowing which shows have better seats available.

In order to enter a bid, the prospective buyer must specify:
which show or shows he/she is willing to attend. The option to include as many as desired will be given along with a warning that once an offer to purchase is accepted it is final and irrevocable;
for each show specified, how many tickets are desired;
the price to be paid per ticket;
how the tickets are to be grouped. It is presumed that generally people will want all of their tickets together but those who want large numbers of tickets (subject to maximums set by the convert promoter) may wish to specify non contiguous blocks; and
any other limits. For example, a buyer may refuse to purchase seats in the upper bowl if that is all that is available when the amount he/she is willing to pay is matched against the ticket allocation.

Even greater flexibility is possible if a promoter is willing to allow buyers to bid on shows at different venues. For example, assume that after the rock bank concludes its shows at venue A on the 1^{st}, 3^{rd} and 5^{th}, they will next play another nearby venue on the 9^{th}, 11^{th}, 13^{th} and 15^{th}. The promoter has the option of putting all the shows at both venues on sale and allowing prospective buyers to specify which dates and venues they wish to bid on. Aside from opening up a larger number of options, this may cater to die-hard fans who make it a point to see their favorite bands several times during a tour.

Artists or concert promoters may want to impose their own conditions on ticket sales. For example, a promoter may want to require the purchase of a minimum number of tickets, or conversely may prohibit a single buyer from buying more than a specified number of seats to any given show. Additionally, a promoter may want to set a minimum bid, to benefit a charity or to create an element of exclusivity, or a maximum bid to redress perceived unfairness in allocating the best seats to the people who pay the most. A maximum allowable bid would effectively define the price for the best seats, but this may be desirable under certain circumstances.

### Versions of Software for Mobile Devices

The internet software that automates this method of selling tickets can be adapted for use as a mobile device application. From a mobile device, a user downloads an application that connects to the internet to obtain listings of events for which tickets are or will be sold using this method. The application allows the user to search for events by the name of the event, by city, by date or other criteria. Once an event is selected, information regarding the terms of the sale is provided along with an internet link to a page where the method of ranking of seats in the venue is visible.

By following web based prompts, a buyer enters all of the information necessary to make a purchase, indicating which events and venues are desired, how many seats are desired, and the amount to be offered per seat. The application software prompts for all applicable limits and restrictions, and requests the input of a credit card number and email address. Before an offer is accepted, the buyer is warned that if his or her bid is matched up to seats for the specified events the credit card will be charged and the purchase is final.

The mobile device application allows a buyer to personalize his or her buying experience by creating a profile wherein his or her email address and credit card information is saved, and by notifying the buyer of upcoming events that meet user-defined criteria.

Additionally, promoters may target advertising to people who download the mobile device application. Furthermore, by delivering a code or scannable picture to the mobile device, the mobile device itself can be used as one or more tickets to the subject event.

### Use of Credit Cards in Lieu of Tickets to Cut Down on Reselling

The act of allocating tickets based on the price that the buyer is willing to pay will cut down dramatically on ticket scalping and reselling because this method allocates tickets based solely on price, thereby eliminating the discrepancy between the amount paid and the value of the ticket to the purchaser.

Nevertheless, an additional step can be utilized at the concert promoter's option to further limit the ability to resell tickets. At the conclusion of the sale, instead of allocating tickets that grant license to enter the venue, the method can require the successful buyer to present either the credit card that was used to make the purchase or another card that confirms that the buyer is the ticket recipient. This latter method may be used when tickets are purchased by one party (a parent or a friend giving a gift) and transferred to another party (a teenager or other gift recipient). This way, there will be no tickets to transfer or resell until the buyer or gift recipient arrives at the venue for the concert. When the concert goer arrives at the venue, he/she must present the credit card in order to be admitted with his or her guests. This process can be automated by use of a machine that upon reading the credit card either prints tickets or simply admits the card holder and the specified number of ticket holders to enter. Such a machine is similar to a machine that dispenses pre-purchased movie tickets. For added security, the buyer can be required either to enter the zip code of the credit card billing address or a code that is provided when the buyer was notified that they had been allocated tickets.

If paper tickets are eliminated and admission is based solely on presentation of a credit card, a collateral environmental benefit is realized, for example, parents would be allowed to buy tickets for children, or a friend to buy tickets for another friend. The recipient of the gift would simply have to present the credit card that was used to make the purchase. This forecloses the sale or transfer of tickets to strangers to whom a person would not give his or her credit card and thereby further limits the resale of tickets.

### Additional Sales Opportunities

At the time when people make their offers to purchase tickets, they can be offered the opportunity to purchase ancillary items such as parking passes, programs, and souvenirs. Parking passes are a natural compliment to ticket sales, and can be delivered in the same way as tickets, generally by printing them at home. Concert goers may like the opportunity to have an official concert t-shirt to wear to the concert, and this presents an additional opportunity to sell team branded merchandise or event programs ahead of the event. Souvenirs can either be shipped prior to the event (in which case shipping charges are added), or picked up at the event from designated vendors in exchange for prepaid vouchers that can be printed at home.

### Other Applications

This type of ticket auction can be used to sell tickets to sporting events. For example, many teams maintain long waiting lists for season tickets, and have even instituted the practice of charging fans an annual fee for the privilege of maintaining their place on the waiting list. In order to realize greater revenue and to eliminate the perceived unfairness of allocating newly available seats to those who had the foresight to put their name on a list months or years in advance, teams could advertise newly available season ticket seats at the beginning of each season and set an open bidding period. Once accepted, each season ticket holder can be offered the option to renew on terms of the team's choosing, for example at the price paid last year plus a percentage increase.

Similarly, tickets for National Hockey League, Major League Baseball, and National Basketball Association playoff games are typically offered in the prior art to the general public in blocks that require a purchaser to buy seats to each game of each playoff round (three or four games, depending on whether the team has earned the home advantage). Teams require fans to purchase tickets in blocks in order to guarantee that all tickets are sold to the fewest number of buyers; but faced with the prospect of having to buy tickets to several games to be played in a short period of time, fans often make the purchase (if they can get tickets at all) with the intent of reselling what they do not plan to use. They do this frequently by either scalping the tickets themselves or by selling them to a reseller who in turn sells them again. Each resale represents potentially lost revenue to the team. By adopting the auction model, teams will realize greater revenue and reduce the prevalence of ticket scalping. Selling playoff tickets by auction to the general public will also create a new incentive for fans to buy season tickets which come with the right to purchase playoff tickets before they are made available to non-season ticket holders.

Other events that lend themselves to the present computer-implemented auction sales model include charity benefit shows (where the auction model would increase the amount raised for charity), premieres or finales, award shows, circuses, children's shows (Ice Capades, Sesame Street Live, Dora The Explorer, and the like) and limited guest star engagements (e.g., Nathan Lane and Matthew Broderick in The Producers).

The novel auction model of the present invention is flexible. Purchasers can easily specify which dates they are willing to buy, how much they are willing to pay, and which seats would be acceptable. In the event a promoter wants to hold aside tickets for sale at a lower price to students, blocks of tickets can be set aside at the box office for purchase upon presentation of a student identification card, or online by entering a code that is published on advertisements targeted to students. Such a code could be used either to allow a student or a senior citizen to buy tickets at a reduced set price, or as a credit equal to a pre-determined percentage discount. In this latter example, a student/senior discount of 15% would mean that a bid of $10 would be treated as a bid of $11.50 and would be matched with a ticket accordingly.

Furthermore, the present computer-implemented auction model utilizes existing computer-implemented distribution methods and does not increase the costs associated with advertising or selling tickets.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A computer-implemented method for allocating a plurality of seat tickets in a venue to a plurality of ticket purchasers, comprising the steps of:
a) forming a ranking of said seats from most desirable to least desirable;
b) accepting a plurality of bids by one or more bidders for tickets to said seats;
c) forming a ranking by monetary value of said bids from highest to lowest; and
d) matching said seat ranking to said bid ranking, wherein the highest bid is assigned the most desirable seat and the lowest bid is assigned the least desirable seat.

2. A computer-implemented method in accordance with claim 1 wherein said ranking of seats is carried out by perceived desirability of said seats.

3. A computer-implemented method in accordance with claim 2 wherein said ranking of seats comprises the steps of:
a) assigning a plurality of equally-desirable seats to a block; and
b) forming a plurality of said blocks of seats.

4. A computer-implemented method in accordance with claim 3 wherein said plurality of blocks are ranked by desirability, and wherein said matching step is carried out with respect to said plurality of blocks.

5. A computer-implemented method in accordance with claim 1 wherein said accepting step is carried out between predetermined first and second dates, and said matching step is carried out after said second date.

6. A computer-implemented method in accordance with claim 5 comprising the further step of making public said ranking of seats before said first date.

7. A computer-implemented method in accordance with claim 1 wherein an individual bidder may submit a plurality of bids on a plurality of seats, which may be adjacent one another.

8. A computer-implemented method in accordance with claim 1 wherein each bid is a binding contract to purchase the assigned ticket by its respective bidder.

9. A computer-implemented method in accordance with claim 1 wherein each bid includes the number of a valid credit device to be charged after said matching step.

10. A computer-implemented method in accordance with claim 9 wherein each assigned ticket is conveyed to its respective matched bidder.

11. A computer-implemented method in accordance with claim 10 wherein each ticket-holding bidder must present said valid credit device for verification to gain entry to said venue.

12. A computer-implemented method in accordance with claim 1 wherein said venue is a sports arena, stadium, concert arena, or the like, and wherein said ticket entitles the bearer thereof to entry to said venue for a specific event thereat.

13. A computer-implemented method in accordance with claim 1 wherein a portion of the total number of said tickets for said event is withheld from entry into said forming, bidding, and matching steps.

14. A computer-implemented method in accordance with claim 1 wherein a portion of the total number of said seats in said venue is withheld from entry into said forming, bidding, and matching steps.

15. A computer-implemented method in accordance with claim 12 wherein said specific event is repeated at a plurality of performances and wherein any of said bids may pertain to any of said performances.

16. A computer-implemented method in accordance with claim 1 wherein any tickets remaining after said matching step are sold conventionally.
